(19) United States
(12) Patent Application Publication
(10) Pub. No.: US 2013/0089034 A1
(43) Pub. Date: Apr. 11, 2013

(54) SEPARATE ASSOCIATIONS OF A MOBILE TO DIFFERENT BASE STATIONS IN UPLINK AND DOWNLINK

(71) Applicants: Joydeep ACHARYA, Sunnyvale, CA (US); Sudhanshu GAUR, Santa Clara, CA (US); Long GAO, Santa Clara, CA (US)

(72) Inventors: Joydeep ACHARYA, Sunnyvale, CA (US); Sudhanshu GAUR, Santa Clara, CA (US); Long GAO, Santa Clara, CA (US)

(73) Assignee: HITACHI, LTD., Tokyo (JP)

(21) Appl. No.: 13/253,907

(22) Filed: Oct. 5, 2011

(51) Int. Cl. H04W 72/04

(52) U.S. Cl. 370/329

(57) ABSTRACT

In a cellular system a user equipment (UE) can associate with different base stations (BS) for its uplink (UL) and downlink (DL) communications. To achieve this, the two BS have to communicate with each other. Systems and methods described herein provide a signaling methodology within a cellular standards framework (such as LTE), by which a UE can associate with different BS for UL and DL communications and further facilitate communication between a BS handling UL and a BS handling DL.

### BACKGROUND

1. Technical Field

This invention is directed generally to communication systems, and more specifically, for selecting base stations (BS) to handle the uplink and/or the downlink of a user equipment (UE).

2. Background Art

In most wireless systems there are user equipments (UE), such a mobile phone, laptop or PDA, that interact with a centralized entity called the Base Station (BS). These could be cellular base stations or wireless local area network (WLAN) access points (AP).

FIG. 1 is an example of a basic interaction between UEs 103 and 104, and a BS 105. Transmissions from the BS to the UE are called downlink (DL) transmissions 101. Transmissions from the UE to the BS are called uplink (UL) transmissions 102. From the UEs point of view, data is received from the BS via a DL channel and data is transmitted to the BS via the UL channel.

The link gain (loss) of a wireless channel depends on several factors and can be expressed as

Loss=PL+S+F+G_{Ant}+L_{Misc} (1)

PL is the path loss, S is the large scale shadow fading, F is the small scale multipath fading, G_{Ant} is the antenna gain factor and L_{Misc} are the other miscellaneous gain factors. The path loss and fading parameters are dependent on the frequency of the signal being transmitted.

The first action of a UE when it switched on is to associate with a BS. For a given UE, the newly associated BS is then responsible for the following:

a) Transmission of control information to the UE;

b) Transmission of data to the UE;

c) Reception of control information from the UE;

d) Reception of data from the UE.

FIG. 2 illustrates an example of control and data transmission between a BS and UEs. In this case both UEs 103 and 104 are associated with (i.e. connected by handshake and address, or other methods) the BS 105. In order for a transmission to be successful, the signal to noise ratio (SNR) or signal to interference plus noise ratio (SINR) of the link or association should be above a certain threshold. The SINR depends on the link gains of all links between a given UE and each of the multiple BSs that may exist in the network. Control channels 200 and data channels 201 have different SNR and SINR requirements for successful transmission.

FIG. 3 illustrates an example of having one or more of the BSs 301, 302, 303 sending a reference signal (RS) to a UE 300 in a respective DL transmission. When the UE 300 switches on, it measures signals coming from each BS in range or in the network. One such signal is the reference signal (RS), which comprises synchronization symbols for cellular and AP beacons in case of WLAN. In the illustrated example, each BS 301, 302 and 303, transmits a respective RS 311, 312, 313 in their respective DL channel periodically. The received signal strength at the UE is called the RS received power (RSRP) and is given in terms Pᵢ, of the transmit power of BSᵢ for losses Lossᵢ as shown in formula (2):

RSRPᵢ=Lossᵢ+Pᵢ (2)

The UE measures RSRP of each BS and, on the basis of a selection mechanism, associates with a BS with the maximum value of RSRP.

In the example of FIG. 3, the UE association is done based on the DL channel RSRP which is dependent on the DL channel link gain. By contrast, in the example of FIG. 2, a UE 103 or 104 sends to the same BS subsequently for both UL and DL transmissions.

Normally, basing the selection only on the DL channel of RSRP wouldn't be a problem if the UL channel from the UE to the BS is also the strongest channel amongst the set of all available UL channels to different BSs. However the UL and DL channels usually operate on different frequency bands, as most wireless systems deploy frequency division duplexing (FDD) to separate the UL and DL transmissions. As previously noted, the path loss and fading parameters of formula (1) are dependent on the frequency of operation. Thus, even though the distance between UL and BS is the same for UL and DL transmissions, the actual path gain(loss) can be different.

FIG. 4 illustrates an example where the UL operates in frequency band f_{U} and the DL in band f_{D} where the UE 103 is a distance d away from the BS 105. Though the DL 400 loss L_{D}(f_{D}, d) may be good it is possible that the UL 401 loss L_{U}(f_{U},d) is not so good.

Such DL-UL imbalance in link gains is not an uncommon problem. In cellular systems that are Third Generation Partnership Project Universal Mobile Telecommunication Systems (3GPP UMTS), where there are serving cells that provide active communication and non-serving cells that are not in active communication, a UE in a soft handoff can handle DL-UL imbalance up to a certain extent. A serving cell could have the stronger DL but the UL to a non-serving cell could be stronger than that to the serving cell. Both 3GPP Release 99 (R99) and High Speed Uplink Packet Access (HSUPA) sessions can exploit this inherent diversity by using soft handoff techniques and by continuing to operate in the presence of some DL-UL imbalance. However, with High Speed Downlink Packet Access (HSDPA) and Long Term Evolution (LTE), a connection of the UE via the UL to the serving cell is crucial for feedback control information. HSDPA and LTE throughput can be severely impacted as a result of DL-UL imbalance. One way to mitigate this problem would be to change serving cells based not just on DL quality but UL quality as well.

The problem is more serious in the heterogeneous networks setting of 3GPP, where different BSs can have different transmit powers.

FIG. 5 illustrates an example of a network having a macro BS 105 and a pico BS 500, such that different BS can have different transmit powers. Based on formula (2), the UE decides to associate with the macro BS 105 over the picocell (pico BS 500) if

Loss_{Macro}+P_{Macro}≧Loss_{Pico}+P_{Pico} (3)

Although the UE 103 is closer to the pico BS 500 in FIG. 5, the UE 103 may associate with the macro BS 105 in this scenario because of a large imbalance in transmit power. For 3GPP scenarios, P_{Macro}=46 dBm and P_{Pico}=30 dBm. However, when the UE transmits over the UL to the BS 105, it does with its own power P_{UE} which is much lower in comparison to P_{Macro}. Thus the following problems will arise for the UL transmission:

a) Since the UE 103 is located far away from the macro BS 105, the received signal strength to the macro BS 105, may be weak.

b) The macro BS 105 could have scheduled another nearby UE 104 in the transmission slot it has to receive data from UE 103, and may not have a transmission slot ready for UE 103.

c) The UE 103, if communicating with macro BS 105, can still cause interference to the Pico BS 500 as it is closer.

The approach in 3GPP to tackle this problem has been to add an association bias in the pico cells received signal strength in formula (3). This ensures that a UE will be associated with a closest pico BS. Nonetheless, the DL will experience problems, because the UE is associated with the pico BS, but the signal from the macro BS, which is stronger, will now create interference.

FIG. 6 illustrates an example of how adjacent cell transmission between a UE and two macro BSs can cause interference. For a UE 600 located at the cell edge of BS 601 and BS 602, the UE may end up being associated with BS 601 due to a slightly higher signal strength 603 from BS 601. However, the signal 604 from BS 602 may cause interference with signal 603.

### CITATION LIST

ITU-R M.2135, “Guidelines for evaluation of radio interface technologies for IMT-Advanced”, December 2009.
E. Dahlman, S. Parkvall, J. Skold, “4G LTE/LTE-Advanced for Mobile Broadband”, Academic Press, 2011.
Y. Tokgoz, F. Meshkati, Y. Zhou, M. Yavuz, S. Nanda, “Uplink Interference Management for HSPA+ and 1×EVDO Femtocells”, in proceedings of IEEE Globecom 2009.
F. Meshkati, Y. Jiang, L. Grokop, S. Nagaraja, M. Yavuz, S. Nanda, “Mobility and Femtocell Discovery in 3G UMTS Networks”, 2010.
3GPP TR 36.814 V9.0.0, Technical Report, 3rd Generation Partnership Project; Technical Specification Group Radio Access Network; Evolved Universal Terrestrial Radio Access (E-UTRA); Further advancements for E-UTRA physical layer aspects (Release 9), March 2010.
U.S. Pat. No. 6,993,341 B2, “Uplink, Downlink diversity for fast cell site selection”, J. Hunzinger, Jan. 31, 2006.
U.S. Patent Publication No. US20100323749 A1, “Method for performing Downlink/Uplink Handover”, J. Lee, Y. H. Kim, K. S. Ryu, Dec. 23, 2010.
U.S. Pat. No. 7,535,867 B1, “Method and System for a Remote Downlink transmitter for increasing the capacity and Downlink capability of a multiple access interference limited spread spectrum wireless network”, D. Kilfoyle, T. Slocumb, S. Carson, May 19, 2009.
PCT Patent Application No. WO2010105398 A1, “Method, Equipment and Network Device for controlling power”, Zhao Mingyu et al, Sep. 23, 2010.
3GPP TS 36.420, X2 general aspects and principles, (Release 10), June 2011.
3GPP TS 36.422, X2 signaling support, (Release 10), June 2011.
3GPP TS 36.423, X2 application protocol (X2AP), (Release 10), June 2011.
3GPP TS 36.201 LTE Physical Layer—General Description (Rel 8), March 2009.

### SUMMARY OF THE INVENTION

### Technical Problem

Given the foregoing background, there is a need for new methods and systems that substantially obviate the aforementioned problems associated with known conventional techniques for communication systems. Specifically, there is a need for assigning an appropriate one or multiple BSs to handle the downlink and/or uplink of a UE while sufficiently addressing the interference issues.

### Solution to the Problem

The inventive methodology is directed to methods and systems that substantially obviate one or more of the above and other problems associated with the known conventional techniques for communication systems.

Aspects of the exemplary embodiments include a first base station that handles downlink transmission for a UE, which may involve an identifier (ID) generation module that generates an ID for a user equipment (UE), a receiver at the UE that receives a plurality of signal strength values from a plurality of base stations; a selection module that assigns a second base station selected from a group of neighboring base stations on the basis of a highest signal strength value from the plurality of reception signal strength values to handle uplink traffic for the UE corresponding to the ID.

Aspects of the exemplary embodiments may also include a method for operating a base station handling downlink transmission for a user equipment (UE), which involves generating an identifier (ID) for the UE; receiving a plurality of received signal strength values from a plurality of base stations; using a signal processor to assign a second base station from the plurality of base stations with a highest metric from the plurality of received signal strength values to handle uplink traffic for the UE corresponding to the ID.

Aspects of the exemplary embodiments may also include a method for handling downlink and uplink transmission for a user equipment (UE), which involves assigning a first base station to the UE for downlink transmission; generating an identifier (ID) for the UE; receiving a plurality of received signal strength values from a plurality of base stations; and using a signal processor to assign or select a second base station from the plurality of neighboring base stations based on a highest metric from the plurality of received signal strength values, and assign the selected base station to handle uplink transmission for the UE corresponding to the ID.

Additional aspects related to the exemplary embodiments will be set forth in part in the description which follows, and in part will be obvious from the description, or may be learned by practice of the invention. Aspects of the exemplary embodiments may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### Advantageous Effects of the Invention

The exemplary embodiments of the invention may associate an appropriate BS to handle the downlink of a UE while associating an appropriate BS to handle the uplink for the UE to avoid problems with interference. The BS handling the downlink may not necessarily be the same as the BS handling the uplink in order to provide improved gain and lessened interference.

### BRIEF DESCRIPTION OF THE DRAWINGS

FIG. 1 illustrates an example of a basic interaction between UEs and a BS.

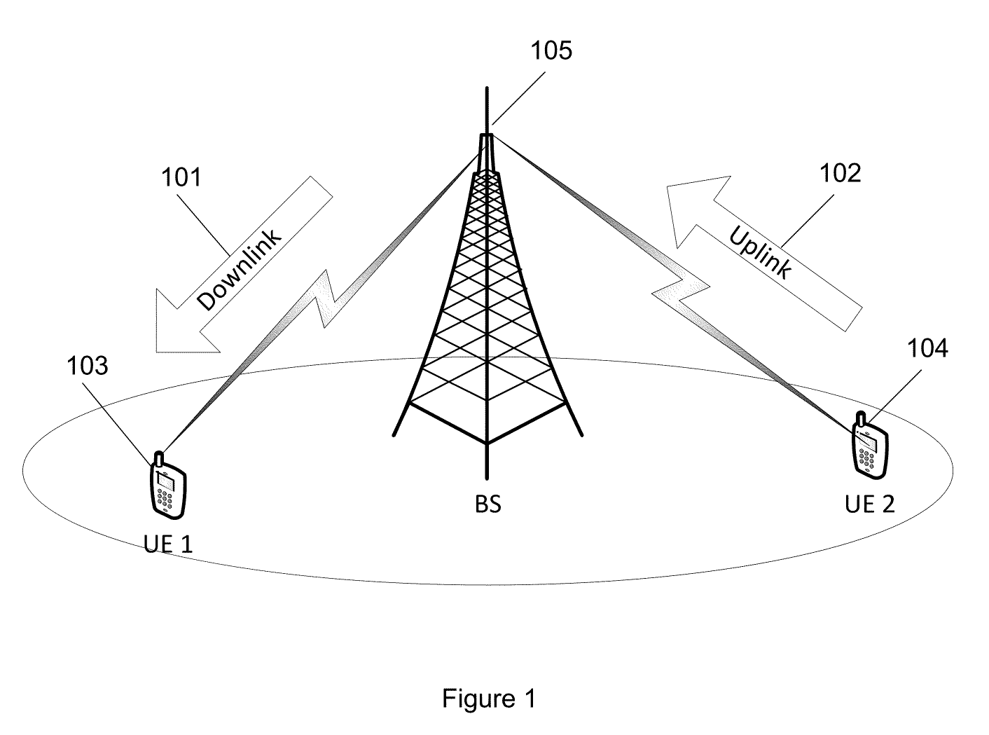

FIG. 2 illustrates an example of control and data transmission between a BS and UE.

FIG. 3 illustrates an example of having a BS send a reference signal (RS) to the UE in the DL.

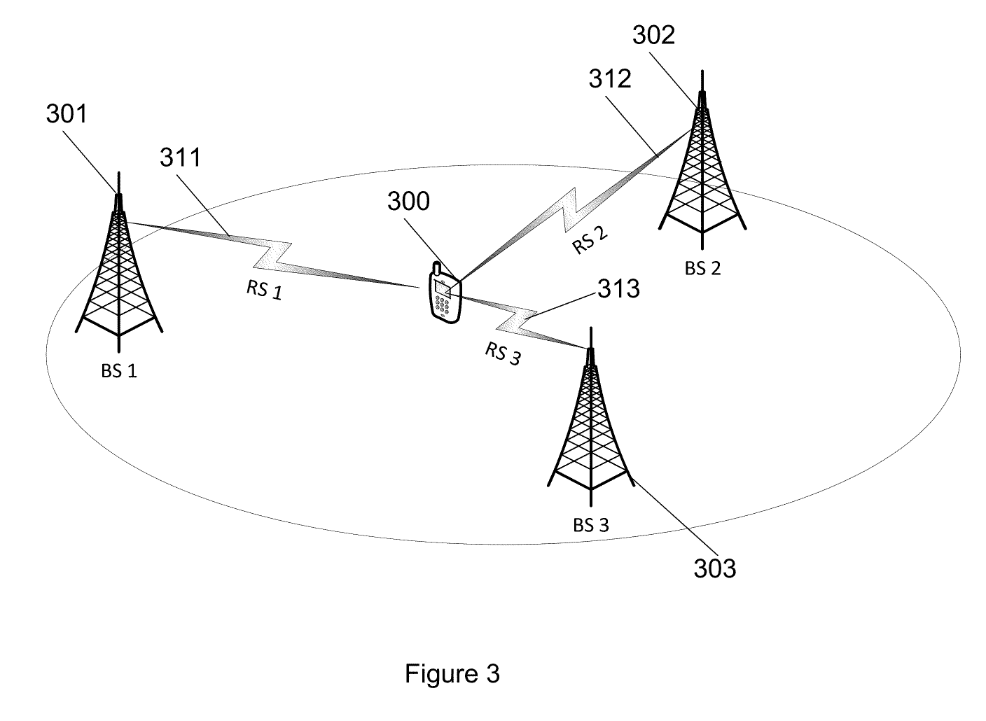

FIG. 4 illustrates an example where the UL operates in frequency band f_{U} and the DL in band f_{D}.

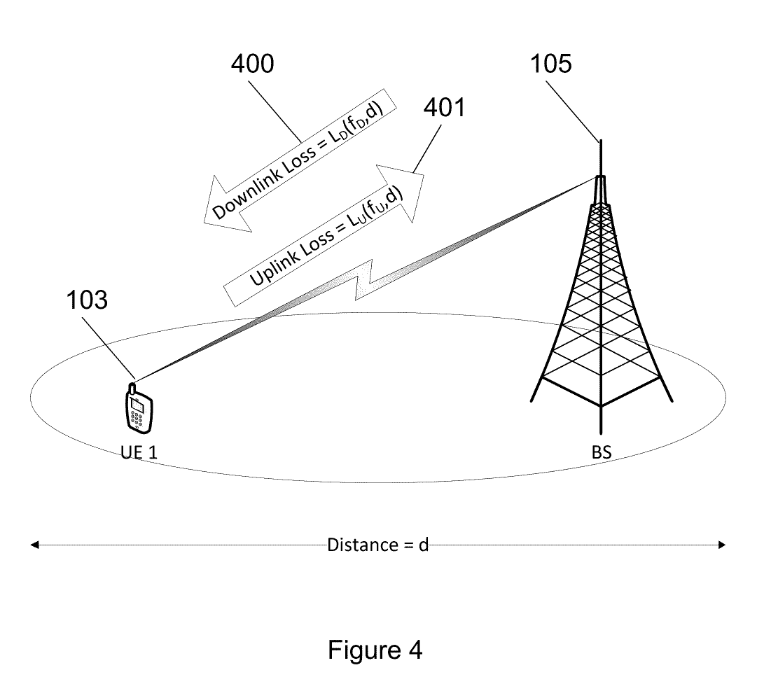

FIG. 5 illustrates an example where different BS can have different transmit powers.

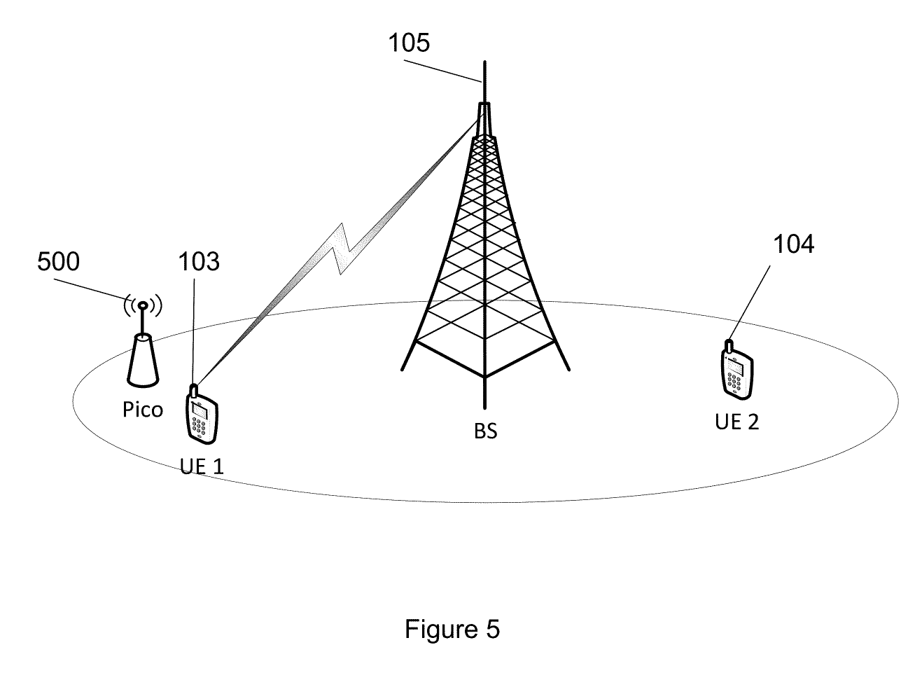

FIG. 6 illustrates an example of how adjacent cell transmission can cause interference.

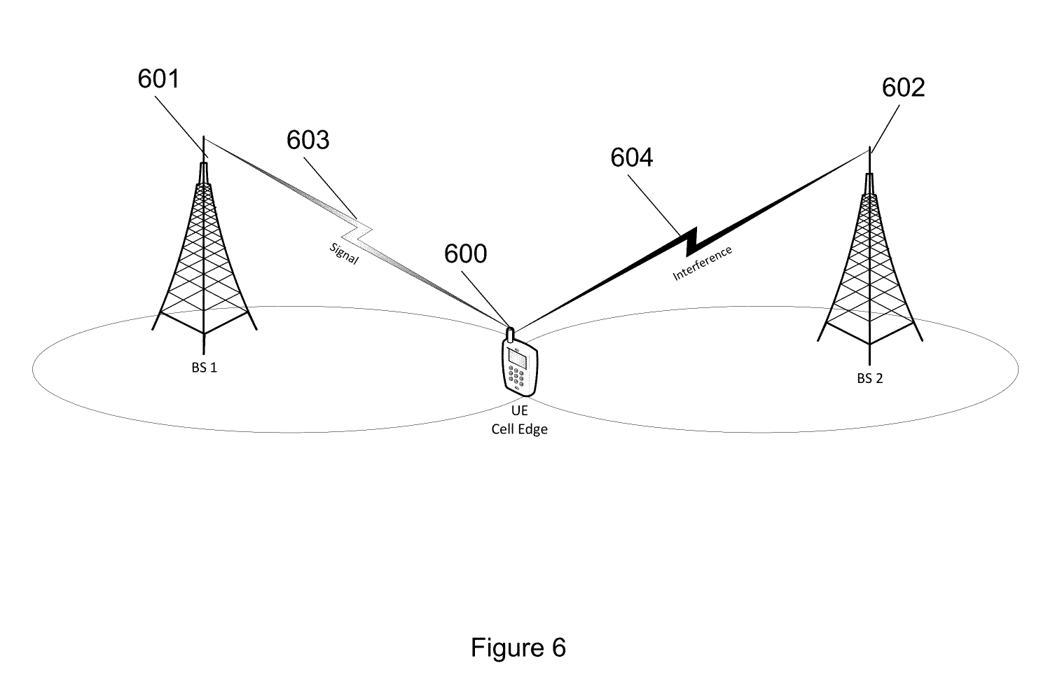

FIG. 7 illustrates an example of how CoMP can be utilized to avoid the adjacent cell transmission problems for the downlink.

FIG. 8 illustrates a basic conceptual example of separate associations of a UE to different BS in UL and DL.

FIG. 9 illustrates a flowchart for showing a method for the association process by which the UE associates to the two BS in accordance to an exemplary embodiment.

FIG. 10 illustrates an example of base station communication in accordance to an exemplary embodiment.

FIG. 11 illustrates an exemplary protocol stack of an X2 signaling bearer in accordance to an exemplary embodiment. X2 is the protocol that operates the backhaul connecting the different BS and this leads to BS cooperation that is needed for realizing different BS to UE associations in UL and DL.

### DESCRIPTION OF EMBODIMENTS

In the following detailed description of exemplary embodiments, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the exemplary embodiments of the invention as described may be implemented in the form of a software running on a general purpose computer, in the form of a specialized hardware, or combination of software and hardware.

In conventional cellular systems, each BS conducted transmission decisions for their associated UEs. There was no coordination amongst the transmissions from different base station which often lead to increased interference. With improved signal processing capabilities at the base station and also faster and more intelligent backhaul systems, base stations can cooperate to increase the transmission efficiency to the UEs. Coordinated Multipoint Transmission Reception (CoMP) is a recent development that allows base stations to cooperate with each other.

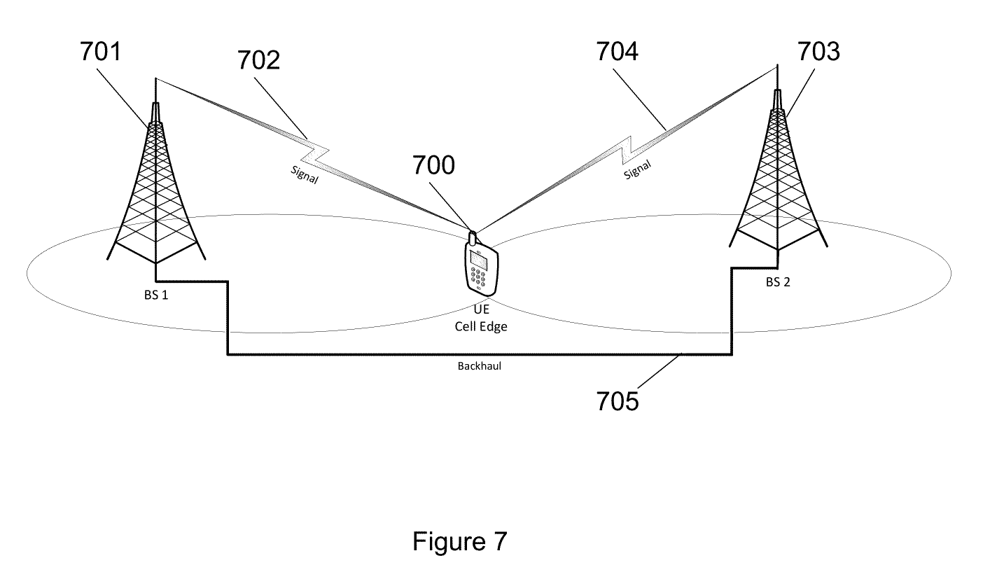

FIG. 7 illustrates how CoMP can be utilized to avoid the adjacent cell transmission problems for the downlink. Based on CoMP, the adjacent cell can transmit in coordination with a serving cell of the UE.

In CoMP systems, each UE 700 is initially associated with one BS 701 that provides a serving cell. However an adjacent cell to the serving cell provided by another BS 703 can form a CoMP set by having the two BSs communicate with each other through a backhaul 705, and together serve the UE in the DL, as represented by signals 702 and 704. The UE 700 may be served by one or many cells in the CoMP set and this pattern can change over time.

Separate Associations of a UE to Different BSs for UL and DL

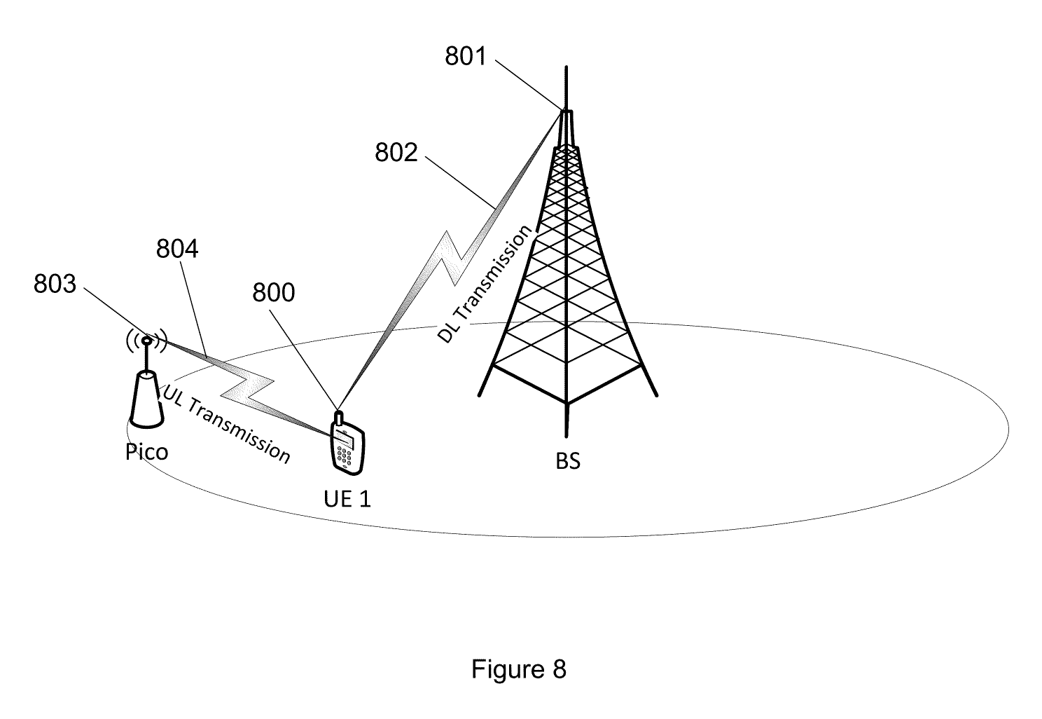

FIG. 8 illustrates a basic conceptual example of separate associations of a UE 800 to different BSs 801, 803 for UL and DL in accordance to an exemplary embodiment. Specifically, the UE 800 is associated with two different BSs 801 and 803; one for handling its UL transmission 804 and one for handling its DL transmission 802. In FIG. 8, the UE 800 may receive DL 802 data from the BS 801, but transmit in the UL 804 to the pico BS 803. This would alleviate both the UL and DL interference problems as mentioned above.

However, in order to realize separate BS associations in UL and DL, the two BS have to communicate with each other. The exemplary embodiments described herein provide signaling methodologies to enable such communication. In previous wireless systems, such BS to BS communication was difficult. Hence, in systems with achievable signaling and protocol level complexities, a UE had to be associated only one BS. The advent of CoMP technology makes BS to BS communication possible. In 3GPP, UL and DL CoMP have been considered separate processes. However, it now has been determined that there is no obstacle for coordinating the UL and DL transmissions by CoMP. The signaling methodology of the exemplary embodiments is based on this CoMP capability.

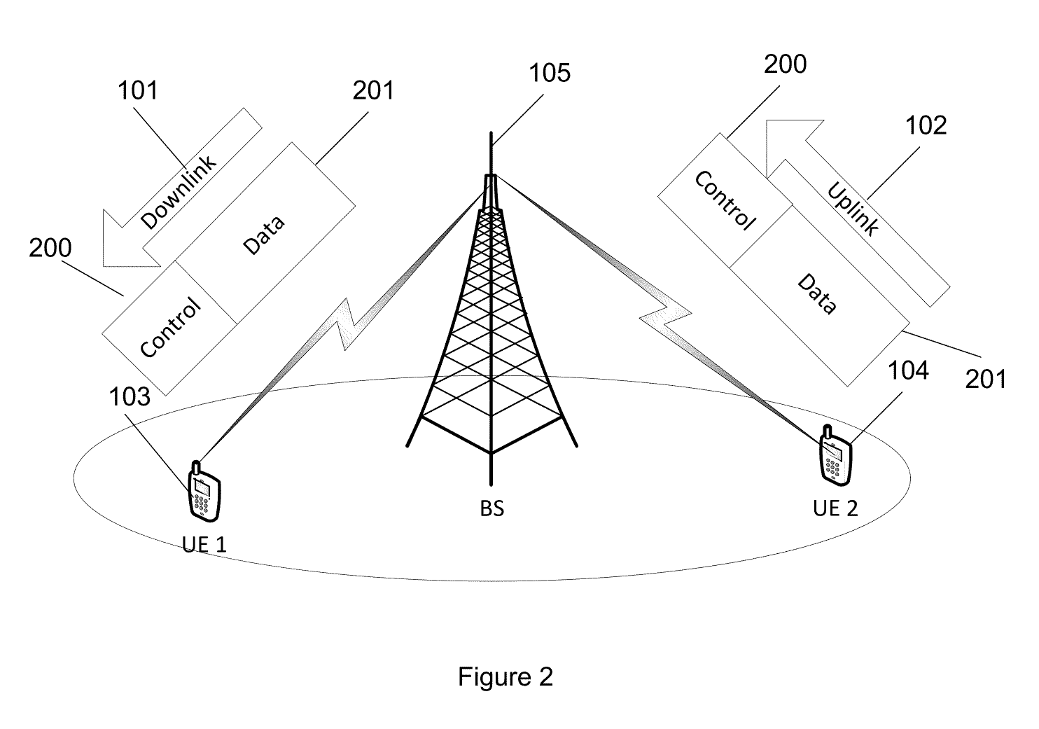

Described herein are detailed signaling procedures between the two BSs in accordance with exemplary embodiments. From FIG. 2, the communication between a BS and a mobile UE involves both data and control information. With CoMP, it is now possible for some control information for uplink transmission to be handled by a separate BS, BS_{UL}, and hence, appropriate control information could be determined by BS_{UL}. An example could be BS_{UL} calculating power control parameters for the UL transmission.

When BS_{UL} calculates power control parameters for the UL transmission, the UE has to be informed about the control information. Exemplary embodiments provide such communication via the DL transmission to the UE, which is not done by BS_{UL}, but by BS_{DL}. Hence BS_{UL} provides the control information to BS_{DL}. There could be other cases whether control information is determined by BS_{UL} and needs to be provided to BS_{DL} so that BS_{UL} can communicate the control information to the UE. Similarly the UE may want to pass some control information to BS_{DL} (such as measured DL channel quality) but since it can transmit only to BS_{UL}, BS_{UL} has to in turn pass the control information to BS_{DL}.

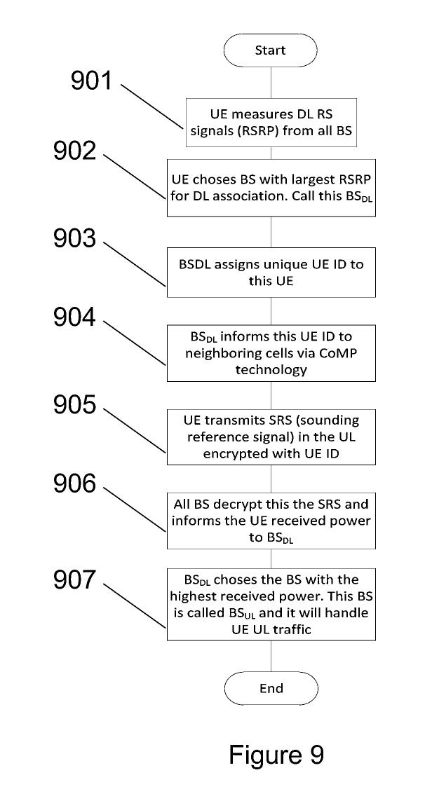

Tables 1 and 2 provide a list of all DL and UL channels that are used in LTE. The DL channels are transmitted to the UE and contain DL data, and control for both UL and DL transmissions. The UL channels are received from the UE and contain UL data and control for both UL and DL transmissions. The DL channels are transmitted by BS_{DL} and the UL channels are received by BS_{UL}. In Tables 1 and 2 we also specify where and how backhaul support is needed. In addition Table 3 shows the other information that needs to be communicated between the two BS based on the flowchart illustrated in FIG. 9.

TABLE 1
Types of DL channels and if backhaul communication is needed
amongst BS to determine the contents of the DL channels

| | | Content | | |
|---|---|---|---|---|
| | | determined | Transmitted | Backhaul |
| DL Channel | Description of content | by | by | Communication |
| PDSCH | DL Data (BSDL to UE) | BSDL | BSDL | None |
| SCH, PBCH, | Important system level | BSDL | BSDL | None |
| PCFICH | control channel information | | | |
| PDCCH (MCS, RB | Control information for DL | BSDL | BSDL | None |
| Allocation) | data reception (PDSCH | | | |
| | reception) | | | |
| PHICH | HARQ control information | BSUL | BSDL | BSUL −> BSDL |
| | for UL Data transmission | | | |
| PDCCH (UL power | Determines transmit power | BSUL | BSDL | BSUL −> BSDL |
| control) | of UE for UL transmission | | | |
| PDCCH (UL grant) | Control information for UL | BSUL | BSDL | BSUL −> BSDL |
| | data (PUSCH transmission) | | | |

TABLE 2
Types of UL channels and if backhaul communication is needed
amongst BS so that the relevant BS gets the information

| | | Received | Intended | Backhaul |
|---|---|---|---|---|
| UL Channel | Description of Content | by | Recipient | Communication |
| PUSCH | UL Data (UE to BSUL) | BSUL | BSUL | None |
| PUCCH (SR) | UE requests BSUL for | BSUL | BSUL | None |
| | opportunity to transmit UL data | | | |
| SRS | UL channel quality measurements | BSUL | BSUL, | None |
| PRACH | Timing alignment, initial access | BSUL | BSUL, | BSUL −> BSDL |
| | of UE to network | | BSDL | |
| PUCCH (CQI/PMI/RI, | Control information for DL data | BSUL | BSDL | BSUL −> BSDL |
| HARQ) | (PDSCH transmission) | | | |

TABLE 3
Other information that could be exchanged
between BS based on FIG. 9.

| | | | Backhaul |
|---|---|---|---|
| Information Type | Generated by | Intended Recipient | Communication |
| UE ID | BSDL | BSUL | BSDL −> BSUL |
| Received Signal | BSUL | BSDL | BSUL −> BSDL |
| Power (SRS | | | |
| Based) | | | |

FIG. 9 illustrates a flowchart showing a method with respect to FIG. 7 by which one UE associates to two BSs in accordance with an exemplary embodiment. First the UE 700 measures the RSRP from the BSs 701, 703 in the downlink and chooses the one with the highest metric, such as the maximum value for power received, in step 901. At step 902, the selected BS 701 will serve the UE in the DL and is called the BS_{DL}. At 903, the BS_{DL} assigns a unique UE ID to this UE and at 904, forwards the UE ID to a plurality of BSes (neighboring BS 703 or any BS within the communication system eligible for handling UL, etc.) via the backhaul 705. The BS_{DL} may use a transmitter to send the UE ID to the BS. At step 905, the UE then sends a UL signal such as a sounding reference signal (SRS), in the UL channel and the plurality of BS decrypts the message via the UE ID at step 906. This is to distinguish its transmission from the other UEs. All BSs receive this transmission and decode the signal using the UE ID. All BSs send the values of the received signal strength to BS_{DL}, over the backhaul via CoMP at 906. Then, the BS_{DL} selects the BS with the highest metric (such as the highest received power value, etc.) at step 907, which may be conducted by a selection module. The selected BS is used as BS_{UL} for the UE associated with the generated ID.

In the example of FIG. 9 there are two BS associated with the UE: the BS_{DL} for DL reception and BS_{UL} for UL transmission. Note that it is also possible that both these BS could be the same, as the BS_{DL} may choose to select itself for the uplink. This could occur in situations where the UEs lie near the cell center of the BS_{DL}.

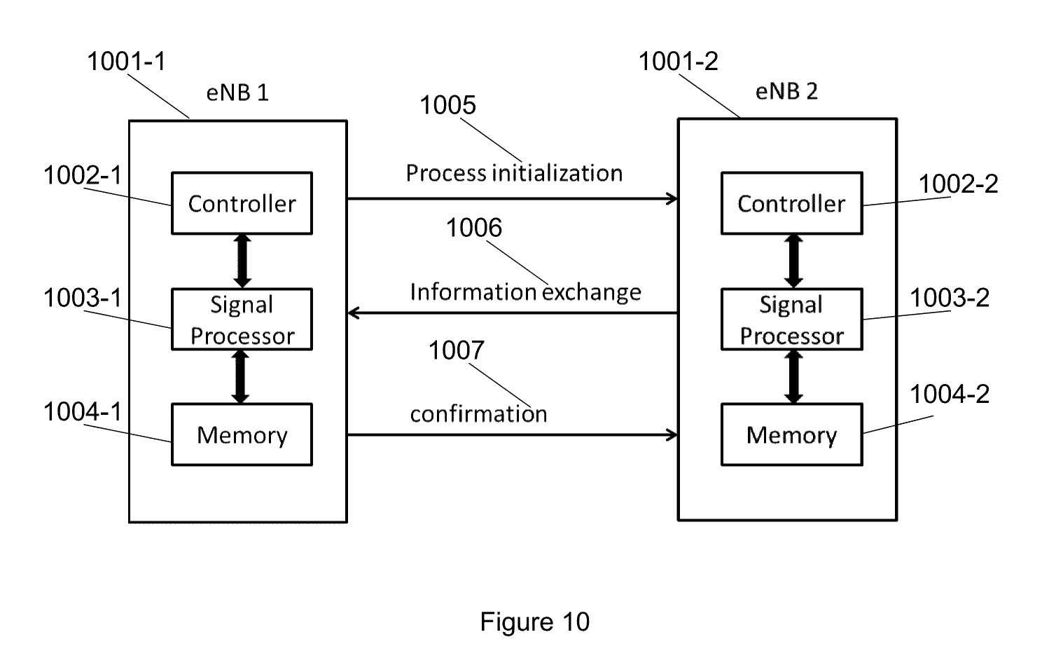

FIG. 10 illustrates an example of base station communication in accordance with an exemplary embodiment. The base stations 1001-1, 1001-2 comprise an evolved node B (eNB) which may include a controller 1002-1, 1002-2, to operate a signal processor 1003-1, 1003-2. Any information to be processed is stored and retrieved from the memory 1004-1, 1004-2. At the initiation, a process initialization message 1005 originates from one of the BSs, followed by subsequent information exchange 1006 and confirmation of correct receipt 1007.

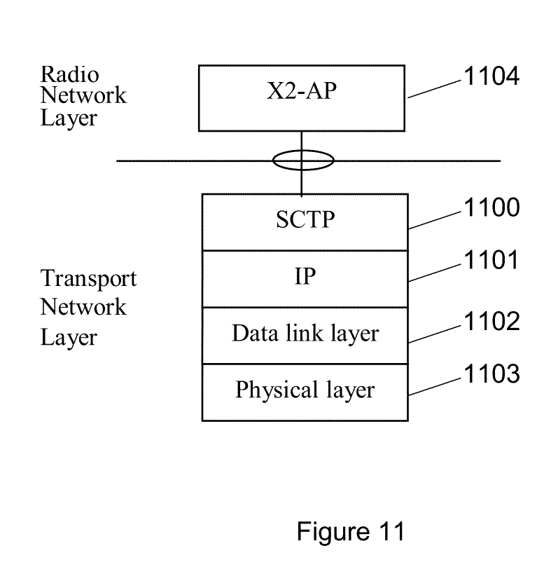

FIG. 11 illustrates an exemplary protocol stack of an X2 signaling bearer in accordance to an exemplary embodiment.

For LTE cellular systems, the backhaul link between BSs is also called the logical X2 interface. The interface could utilize a Stream Control Transmission Protocol (SCTP) 1100, an internet protocol (IP) 1101, a data link layer 1102 and a physical link layer 1103 at the transmission layer. The data to be communicated between BSs is generated and encoded in the X2-AP application layer 1104 at the radio layer. The X2-AP has different procedures for different kinds of functions. Some of these can be re-used for communicating the information in Tables 1-3 as described above.

New “Elementary Procedures” to the X2AP procedure list in the exemplary embodiments. The new procedures, herein described as “Information for UL DL Association Report”, is initiated by the message UL_DL_REPORT. Exemplary embodiments define two new Information Elements (IE) called “UL DL Information Exchange” for BS_{UL} to BS_{DL} communication and “DL UL Information Exchange” for BS_{DL} to BS_{UL} communication. Their contents are determined by Tables 1-3 as described above. A detailed structure of the first IE in Table 4 and the second one in Table 5 are indicated below. This structure is consistent with other IE definitions.

TABLE 4
Structure of IE UL DL Information Exchange. Values in the IE type and reference
field and semantics description are in conformance with conventional LTE numbers.

| | | IE type and | |
|---|---|---|---|
| Group Name | Presence | reference | Semantics description |
| G1_{PHICH Info} | Mandatory | 1 BIT, a0 | a0 = 1 indicates ACK, a0 = 0 indicates |
| | | | NACK |
| G2_{UL power | Mandatory | 2 BIT string | (b0, b1) represent 4 possible values of |
| control info in | | (b0, b1) | aperiodic fast power control used in |
| PDCCH} | | | DCI Formats 0/3/3A |
| G3_{UL Grant info in | Mandatory | 44 BIT string | RB assignment, MCS, hopping flag, |
| PDCCH} | | (c0, c1 . . ., | NDI, cylic-shift of DM-RS, CQI request, |
| | | c43) | 2-bit PUSCH TPC command; mask for |
| | | | antenna selection |
| G4_{PRACH, TA | Mandatory | 12 BIT string | (d0, . . ., d5) Denotes 64 possible values |
| info} | | (d0 . . . d5, | of TA command |
| | | e0, . . . , e5) | (e0, . . . e5) Denotes the PRACH |
| | | | preamble received from the UE |
| G5_{PUCCH | Mandatory | 12 BIT string | Used to convey CQI/PMI/RI + |
| (CQI/PMI/RI, + | | (f0 . . . f11) | ACK/NACK information. 12 bits is the |
| ACK/NACK)} | | | maximum needed(PUCCH format 2b) |
| G6_{Received UL | Mandatory | X BIT string | Used to quantize the received power |
| power info via SRS | | g0, . . ., gX | information. A higher value of X leads |
| measurement} | | | to better quantization. This is a design |
| | | | parameter. X = 5 is a reasonable value |

TABLE 5
Structure of IE DL UL Information Exchange. Values in
the IE type and reference field and Semantics description
are in conformance with conventional LTE numbers.

| | | IE type and | |
|---|---|---|---|
| Group Name | Presence | reference | Semantics description |
| G1_{UE | Mandatory | 4 BIT | Indicates the OFDM symbol |
| ID} | | string, | (in a subframe) where the |
| | | a0, . . ., a4 | UE would transmit SRS. Is |
| | | | an effective UE Id |

With the new IEs defined, the UL and DL BS can effectively communicate with each other, thereby enabling the concept of separate UE association in UL and DL within LTE framework.

The signaling example is given from LTE standard protocols, but the general principles could apply to other cellular standards as well. The exemplary embodiments also identify the type of information that have to be exchanged between these two BS and also proposes methods of signaling them using X2 backhaul technology.

Some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result.

Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus.

Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the invention will be apparent to those skilled in the art from consideration of the specification and practice of the invention disclosed herein. Various aspects and/or components of the described embodiments may be used singly or in any combination in a communication system. It is intended that the specification and examples be considered as exemplary only, with a true scope and spirit of the invention being indicated by the following claims.

What is claimed is:

1. A first base station, comprising:
an identifier (ID) generation module generating an ID for a user equipment (UE);
a receiver receiving a plurality of received signal strength values from a plurality of base stations;
a selection module assigning a second base station from the plurality of base stations with a highest metric from the plurality of received signal strength values to handle uplink traffic for the UE corresponding to the ID;
wherein the receiver receives uplink control information of the UE corresponding to the ID from the second base station.

2. The first base station of claim 1, further comprising a transmitter transmitting the generated ID to the plurality of base stations through a backhaul by using coordinated multipoint transmission reception.

3. The first base station of claim 2, wherein the transmitter transmits a process initialization message to the second base station and transmits a confirmation of receipt of an information exchange packet to the second base station.

4. The first base station of claim 3, wherein the receiver receives uplink control information corresponding to the ID from processing the information exchange packet, and
wherein the transmitter transmits the received uplink control information to the UE corresponding to the ID.

5. The first base station of claim 4, wherein the receiver receives the information exchange packet from the backhaul, and wherein the information exchange packet comprises:
acknowledgement information;
transmission power information indicating uplink transmission power of the UE corresponding to the ID; and
control information for uplink data.

6. The first base station of claim 5, wherein the information exchange packet further comprises:
timing alignment information;
received signal power from the UE corresponding to the ID; and
control information for downlink data.

7. The first base station of claim 1, wherein the ID is a data packet comprising an orthogonal frequency-division multiplexing (OFDM) symbol that the UE transmits received signal power information to.

8. A method for operating a base station handling downlink transmission for a user equipment (UE), comprising:
generating an identifier (ID) for the UE;
receiving a plurality of received signal strength values from a plurality of base stations;
using a signal processor to assign a second base station from the plurality of base stations with a highest metric from the plurality of received signal strength values to handle uplink traffic for the UE corresponding to the ID; and
receiving uplink control information from the second base station of the UE corresponding to the ID.

9. The method of claim 8, further comprising transmitting the generated ID to the plurality of base stations through a backhaul by using coordinated multipoint transmission reception.

10. The method of claim 9, further comprising:
transmitting a process initialization message to the second base station; and
transmitting a confirmation of receipt of an information exchange packet to the second base station.

11. The method of claim 10, further comprising:
processing uplink control information corresponding to the ID, from the information exchange packet, and
transmitting the uplink control information to the UE corresponding to the ID.

12. The method of claim 11, wherein the processing uplink control information further comprises processing, from the information exchange packet, acknowledgement information; transmission power information indicating uplink transmission power of the UE corresponding to the ID; and control information for uplink data.

13. The method of claim 12, wherein the processing uplink control information further comprises processing, from the information exchange packet, timing alignment information; received uplink power information; and control information for downlink data.

14. The method of claim 8, wherein the generating the ID further comprises generating a data packet comprising an orthogonal frequency-division multiplexing (OFDM) symbol that the UE transmits received signal power information to.

15. A method for handling downlink and uplink transmission for a user equipment (UE), comprising:
assigning a first base station to the UE for downlink transmission;
generating an identifier (ID) for the UE;
receiving a plurality of received signal strength values from a plurality of base stations;
using a signal processor to assign a second base station from the plurality of base stations with a highest metric from the plurality of received signal strength values to handle uplink transmission for the UE corresponding to the ID; and
receiving uplink control information corresponding to the ID from the information exchange packet at the first base station, from the second base station.

16. The method of claim 15, further comprising transmitting the generated ID from the first base station to the plurality of base stations through a backhaul by using coordinated multipoint transmission reception.

17. The method of claim 16, further comprising:
transmitting a process initialization message from the first base station to the second base station; and
transmitting a confirmation of receipt of an information exchange packet from the first base station to the second base station.

18. The method of claim 17, further comprising:
transmitting, from the first base station, the received uplink control information to the UE corresponding to the ID.

19. The method of claim 18, further comprising measuring, at the plurality of base stations, transmission power from the UE corresponding to the ID to determine the received signal strength values, and
transmitting, from the second base station to the first base station, uplink control information of the UE corresponding to the ID through a backhaul by using coordinated multipoint transmission reception.

20. The method of claim 19, wherein the transmitting uplink control information from the second base station to the first base station comprises transmitting acknowledgement information; transmission power information indicating uplink transmission power of the UE corresponding to the ID; and control information for uplink data to the first base station.

21. The method of claim 20, wherein the transmitting uplink control information from the second base station to the first base station comprises transmitting timing alignment information; one of the plurality of received signal strength values; and control information for downlink data at the first base station.

22. The method of claim 15, wherein the generating the ID comprises generating a data packet comprising an orthogonal frequency-division multiplexing (OFDM) symbol that the UE transmits received signal power information to.
